(19) United States
(12) Patent Application Publication
(10) Pub. No.: US 2025/0190918 A1
(43) Pub. Date: Jun. 12, 2025

(54) METHODS AND SYSTEMS FOR CLASSIFYING ROOT CAUSE OF SUB-OPTIMAL PRODUCTION PERFORMANCE FOR HYDROCARBON WELLS ASSOCIATED WITH UNCONVENTIONAL RESERVOIRS

(71) Applicant: ExxonMobil Technology and Engineering Company, Spring, TX (US)

(72) Inventor: Ankit BHATNAGAR, Spring, TX (US)

(21) Appl. No.: 18/948,077

(22) Filed: Nov. 14, 2024

Related U.S. Application Data
(60) Provisional application No. 63/606,850, filed on Dec. 6, 2023.

(51) Int. Cl. G06Q 10/0639; G06Q 50/02; G06T 11/20

(52) U.S. Cl. CPC G06Q 10/06393; G06T 11/206; G06Q 50/02

(57) ABSTRACT

A method for classifying the root cause of sub-optimal production performance for hydrocarbon wells includes, for each of multiple wells: determining the expected production performance of the well during multiple units of time via performance forecasting; determining the actual production performance of the well during each unit of time based on measured production data; determining a performance delta value for each unit of time by subtracting the actual production performance from the expected production performance; and determining a volatility in the performance delta values using a statistical metric. The method also includes generating a scatter plot representing production performances of the wells. The scatter plot includes the volatility in the performance delta values for each well versus the most recent performance delta value for the well. The method further includes classifying the root cause of the sub-optimal production performances of the wells based on quadrants of the scatter plot.

### CROSS-REFERENCE TO RELATED APPLICATION

This application claims priority to and the benefit of U.S. Provisional Application No. 63/606,850, entitled “METHODS AND SYSTEMS FOR CLASSIFYING ROOT CAUSE OF SUB-OPTIMAL PRODUCTION PERFORMANCE FOR HYDROCARBON WELLS ASSOCIATED WITH UNCONVENTIONAL RESERVOIRS,” having a filing date of Dec. 6, 2023, the disclosure of which is incorporated herein by reference in its entirety.

### FIELD

This disclosure relates generally to the field of hydrocarbon production and associated hydrocarbon well performance. More specifically, this disclosure relates to classifying the root cause of sub-optimal production performance for hydrocarbon wells associated with unconventional reservoirs.

### BACKGROUND

This section is intended to introduce various aspects of the art, which may be associated with embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Unconventional (or tight) reservoirs are reservoirs with very low permeability. Examples of unconventional reservoirs include tight sandstone reservoirs, tight carbonate reservoirs, shale gas reservoirs, coal bed methane reservoirs, tight oil reservoirs, and tight limestone reservoirs. Hydrocarbon wells associated with unconventional reservoirs often include wellbores with lateral sections that extend for thousands of feet through the corresponding subsurface formation. For example, in many cases, such hydrocarbon wells include lateral sections that are over 1,000 feet in length, in which case the hydrocarbon well may be referred to as an “extended-reach lateral well,” or, in some cases, over 10,000 feet in length, in which case the hydrocarbon well may be referred to as an “ultra-extended-reach lateral well.”

Hydrocarbon production via such hydrocarbon wells is especially challenging due at least in part to the subsurface uncertainties associated with unconventional reservoirs and the operational limitations for the corresponding wellbores. Treatment techniques such as hydraulic fracturing and/or acid stimulation are typically performed for the hydrocarbon wells to facilitate the economic production of hydrocarbons from the corresponding reservoirs. However, due (at least in part) to the extensive length of the lateral sections of the wellbores, subsurface uncertainties and operational limitations still persist. For example, subsurface uncertainties often include (but are not limited to) the extent of degradation caused by interactions with one or more neighboring wells, the extent of fracture interference with one or more neighboring wells, the impact of different fracturing fluid compositions, and/or the heterogeneity in reservoir quality. Moreover, operational limitations often include (but are not limited to) artificial lift issues (e.g., insufficient gas injection rates for gas-lifted wells and/or electric submersible pumps (ESPs) operating outside the design range), operational interference caused by fracture hits from one or more neighboring wells, errors in data measured by sensors, and/or inflow pressure drop caused by scale build-up within the wellbore.

Due (at least in part) to such operational limitations and subsurface uncertainties, hydrocarbon wells associated with unconventional reservoirs tend to suffer from sub-optimal production performance, resulting in reduced production volume and associated value degradation for such wells. However, it can be very challenging to pinpoint the root cause of such sub-optimal production performance due to the difficulty in decoupling the confounding effects of the operational limitations and subsurface uncertainties.

### SUMMARY

An aspect of this disclosure provides a method for classifying the root cause of sub-optimal production performance for hydrocarbon wells associated with one or more unconventional reservoirs. At least a portion of the method can be implemented via a computing system including a processor. The method can include, for each of a number of hydrocarbon wells, one or more of the following steps: determining an expected production performance of the hydrocarbon well during each of multiple units of time via performance forecasting; determining an actual production performance of the hydrocarbon well during each of the multiple units of time based on production data corresponding to hydrocarbon production via the hydrocarbon well; determining a performance delta value for each of the multiple units of time by subtracting the sum of the actual production performance for each unit of time from the sum of the expected production performance for the same unit of time; and determining a volatility in the performance delta values for the hydrocarbon well using a statistical metric. The method can also include generating a scatter plot representing production performances of the hydrocarbon wells, where the scatter plot includes the volatility in the performance delta values for each hydrocarbon well versus the most recent performance delta value for the corresponding hydrocarbon well, and where the most recent performance delta value includes the performance delta value for the unit of time corresponding to the most recently-occurring time period. The method can further include classifying the root cause of the sub-optimal production performance of at least a portion of the hydrocarbon wells based on quadrants of the scatter plot.

A second aspect of this disclosure provides a hydrocarbon well system including multiple hydrocarbon wells, where hydrocarbon fluids are produced from each hydrocarbon well concurrently with the measurement of corresponding production data. The hydrocarbon well system can also include a computing system communicably coupled to the multiple hydrocarbon wells. The computing system can include a processor and a non-transitory, computer-readable storage medium. The non-transitory, computer-readable storage medium can include program instructions that are executable by the processor to cause the processor to conduct one or more of the following: determine an expected production performance of a hydrocarbon well of the multiple hydrocarbon wells during each of multiple units of time via performance forecasting; determine an actual production performance of the hydrocarbon well during each of the multiple units of time based on the production data corresponding to the hydrocarbon well; determine a performance delta value for each of the multiple units of time by subtracting the sum of the actual production performance for each unit of time from the sum of the expected production performance for the same unit of time; determine a volatility in the performance delta values for the hydrocarbon well using a statistical metric; repeat the determination of the expected production performance, the determination of the actual production performance, the determination of the performance delta value for each of the multiple units of time, and the determination of the volatility in the performance delta values for each remaining hydrocarbon well of the multiple hydrocarbon wells; generate a scatter plot representing production performances of the multiple hydrocarbon wells, where the scatter plot includes the volatility in the performance delta values for each hydrocarbon well versus the most recent performance delta value for the same hydrocarbon well, and where the most recent performance delta value includes the performance delta value for the unit of time corresponding to the most recently-occurring time period; and classify the root cause of the sub-optimal production performance of at least a portion of the multiple hydrocarbon wells based on quadrants of the scatter plot.

Another aspect of this disclosure provides a non-transitory, computer-readable storage medium. The non-transitory, computer-readable storage medium can include program instructions that are executable by a processor to cause the processor to conduct one of more of: measure production data corresponding to hydrocarbon production via a hydrocarbon well of multiple hydrocarbon wells; determine an expected production performance of the hydrocarbon well during each of multiple units of time via performance forecasting; determine an actual production performance of the hydrocarbon well during each of the multiple units of time based on the measured production data; determine a performance delta value for each of the multiple units of time by subtracting the sum of the actual production performance for each unit of time from the sum of the expected production performance for the same unit of time; determine a volatility in the performance delta values for the hydrocarbon well using a statistical metric; repeat the determination of the expected production performance, the determination of the actual production performance, the determination of the performance delta value for each of the multiple units of time, and the determination of the volatility in the performance delta values for each remaining hydrocarbon well of the multiple hydrocarbon wells; generate a scatter plot representing production performances of the multiple hydrocarbon wells, where the scatter plot includes the volatility in the performance delta values for each hydrocarbon well versus the most recent performance delta value for the same hydrocarbon well, and where the most recent performance delta value includes the performance delta value for the unit of time corresponding to the most recently-occurring time period; and classify the root cause of the sub-optimal production performance of at least a portion of the multiple hydrocarbon wells based on quadrants of the scatter plot by: (a) classifying any of the multiple hydrocarbon wells that fall within a first quadrant within the top right of the scatter plot with the root cause classification of subsurface uncertainty; (b) classifying any of the multiple hydrocarbon wells that fall within a second quadrant within the top left of the scatter plot with the root cause classification of operation limitation; (c) classifying any of the multiple hydrocarbon wells that fall within a third quadrant within the bottom left of the scatter plot with the root cause classification of subsurface uncertainty and operational limitation; and (d) classifying any of the multiple hydrocarbon wells that fall within a fourth quadrant within the bottom right of the scatter plot with the root cause classification of subsurface uncertainty.

These and other features and attributes of the disclosed embodiments of the present disclosures and their advantageous applications and/or uses will be apparent from the detailed description that follows.

### BRIEF DESCRIPTION OF THE DRAWINGS

To assist those of ordinary skill in the relevant art in making and using the subject matter described herein, reference is made to the appended drawings, where:

FIG. 1 is a process flow diagram of an exemplary method for classifying the root cause of sub-optimal production performance for hydrocarbon wells associated with one or more unconventional reservoirs in accordance with the present disclosure;

FIG. 2 is an exemplary scatter plot of the volatility of the performance delta values for each hydrocarbon well over the measured units of time versus the performance delta value of the corresponding hydrocarbon well for the most recent unit of time;

FIG. 3 is a simplified process flow diagram of an exemplary method for classifying the root cause of sub-optimal production performance for hydrocarbon wells associated with one or more unconventional reservoirs in accordance with the present disclosure;

FIG. 4 is a block diagram of an exemplary cluster computing system that may be utilized to implement at least a portion of the present disclosure; and

FIG. 5 is a block diagram of an exemplary non-transitory, computer-readable storage medium that may be used for the storage of data and modules of program instructions for implementing at least a portion of the present disclosure.

It should be noted that the figures are merely examples of the present disclosure and are not intended to impose limitations on the scope of the present disclosure. Further, the figures are generally not drawn to scale, but are drafted for purposes of convenience and clarity in illustrating various aspects of the disclosure.

### DETAILED DESCRIPTION OF THE PREFERRED EMBODIMENTS

In the following detailed description section, the specific examples of the present disclosure are described in connection with preferred embodiments. However, to the extent that the following description is specific to a particular embodiment or a particular use of the present techniques, this is intended to be for exemplary purposes only and simply provides a description of the embodiments. Accordingly, the present disclosure is not limited to the specific embodiments described below, but rather, includes all alternatives, modifications, and equivalents falling within the true spirit and scope of the appended claims.

At the outset, and for case of reference, certain terms used in this application and their meanings as used in this context are set forth. To the extent a term used herein is not defined below, it should be given the broadest definition those skilled in the art have given that term as reflected in at least one printed publication or issued patent. Further, the present disclosure is not limited by the usage of the terms shown below, as all equivalents, synonyms, new developments, and terms or techniques that serve the same or a similar purpose are considered to be within the scope of the present claims.

As used herein, the singular forms “a,” “an,” and “the” mean one or more when applied to any embodiment described herein. The use of “a,” “an,” and/or “the” does not limit the meaning to a single feature unless such a limit is specifically stated.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the term “erratic,” when used with reference to the production performance of a hydrocarbon well, refers to production performance that varies abruptly over a specified period of time. Conversely, the term “consistent,” when used with reference to the production performance of a hydrocarbon well, refers to production performance that varies gradually or remains relatively steady over a specified period of time.

As used herein, the terms “example,” exemplary,” and “embodiment,” when used with reference to one or more components, features, structures, or methods according to the present disclosure, are intended to convey that the described component, feature, structure, or method is an illustrative, non-exclusive example of components, features, structures, or methods according to the present disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present disclosure.

As used herein, the term “field” (sometimes referred to as an “oil and gas field” or a “hydrocarbon field”) refers to an area including one or more hydrocarbon wells for which hydrocarbon production operations are performed to provide for the extraction of hydrocarbon fluids from a corresponding subsurface formation.

The term “hydrocarbon well system” is used herein to refer to all the hydrocarbon wells and associated equipment within a particular field of interest (or multiple fields of interest that are within relatively close proximity to one another). More specifically, according to embodiments described herein, a hydrocarbon well system includes multiple hydrocarbon wells (with the corresponding wellheads, wellbores, and associated downhole and surface equipment). In addition, according to embodiments described herein, the hydrocarbon well system includes at least one computing system that enables the direction and execution of various hydrocarbon production processes with respect to the hydrocarbon wells within the hydrocarbon well system, including, for example, processes for classifying the root cause of sub-optimal production performance for the hydrocarbon wells, as described herein.

As used herein, the term “operational limitation,” when used with reference to hydrocarbon production via a hydrocarbon well, refers to any operational parameter of the hydrocarbon well that is either unknown (or at least partially unknown) or has an unknown (or at least partially unknown) impact on the resulting hydrocarbon production. Examples of operational limitations include (but are not limited to) artificial lift issues (e.g., insufficient gas injection rates for gas-lifted wells and/or electric submersible pumps (ESPs) operating outside the design range), operational interference caused by fracture hits from one or more neighboring wells, errors in data measured by sensors, and/or inflow pressure drop caused by scale build-up within the wellborc.

The term “sub-optimal,” when used herein with reference to the production performance of a hydrocarbon well, refers to production performance that fails to meet a predetermined expectation. As an example, the predetermined expectation may include a specified value or range for the expected production volume per unit of time (e.g., barrels of oil per day or cubic feet of gas per day). If the actual production volume per unit of time is below the specified value or range, the hydrocarbon well is underperforming. If the actual production volume per unit of time exceeds the specified value or range, the hydrocarbon well is overperforming. In both cases, the production performance of the hydrocarbon well is considered to be sub-optimal since it does not meet the specified value or range and, thus, does not meet the predetermined expectation for production performance. As another example, the predetermined expectation may include a specified value or range for the expected pressure normalized rate (sometimes referred to as the “productivity index”) for the hydrocarbon well, where such expected pressure normalized rate is determined by dividing the expected production volume per unit of time by the pressure drawdown for the hydrocarbon well. Moreover, more generally speaking, the predetermined expectation for the production performance may include (but is not limited to) the expected production rate (for any phase), the expected flowing bottomhole pressure, the expected tubing head pressure, the expected casing pressure, the expected bottomhole temperature, the expected gas-to-oil ratio, the expected water-to-oil ratio, and/or any other quantifiable expectation that can be derived from a combination of such parameters (such as the pressure normalized rate, as described above).

As used herein, the term “subsurface uncertainty” refers to any unknown (or at least partially unknown) parameter corresponding to a subsurface formation. Examples of subsurface uncertainties include (but are not limited to) the extent of degradation caused by interactions with one or more neighboring wells, the extent of fracture interference with one or more neighboring wells, the impact of different fracturing fluid compositions, and/or the heterogeneity in reservoir quality.

The term “wellbore” refers to a borehole drilled into a subsurface formation. The borehole may include vertical and/or lateral sections, where the term “lateral” as used herein is intended to encompass (not only fully horizontal wellbore sections) but also wellbore sections that are deviated but not fully horizontal. The term “wellbore” also includes the downhole equipment associated with the borehole, such as the casing strings, production tubing, gas lift valves, and other subsurface equipment. Relatedly, the term “hydrocarbon well” (or simply “well”) includes the wellbore in addition to the wellhead and other associated surface equipment.

Turning now to details of the present disclosure, as described above, hydrocarbon wells associated with unconventional reservoirs tend to suffer from sub-optimal production performance. However, according to current techniques, it can be very difficult to pinpoint the root cause of the sub-optimal production performance. Accordingly, the present disclosure alleviate this difficulty and provide related advantages as well. In particular, this disclosure provides methods and systems for classifying the root cause of sub-optimal production performance for hydrocarbon wells associated with unconventional reservoirs. More specifically, according to the present disclosure, hydrocarbon wells exhibiting sub-optimal production performance are automatically identified, and the sub-optimal production performance for each hydrocarbon well is automatically classified as being caused by operational limitations, subsurface uncertainties, or some combination thereof. This is accomplished by determining the expected production performance of each hydrocarbon well using production forecasting techniques and then calculating the difference between the expected production performance over a certain period of time and the actual production performance over the same period of time, which is referred to herein as the “performance delta value” per unit of time. Performance delta values may then be calculated for different units of time. The volatility in the performance delta values for each hydrocarbon well is determined using a statistical metric. A scatter plot of the volatility of the performance delta values for each hydrocarbon well versus the performance delta value for the corresponding hydrocarbon well for the most recent unit of time is then generated. Quadrant analysis techniques are then applied to the scatter plot, where each quadrant within the scatter plot corresponds to a specific production performance classification. As a result, the scatter plot can be utilized to identify each hydrocarbon well including sub-optimal production performance, as well as to classify the root cause of such sub-optimal production performance. By automatically classifying the root cause in this manner, the present disclosure enables such root cause to be addressed in a timely and efficient manner to increase production volume and avoid value degradation for the hydrocarbon well.

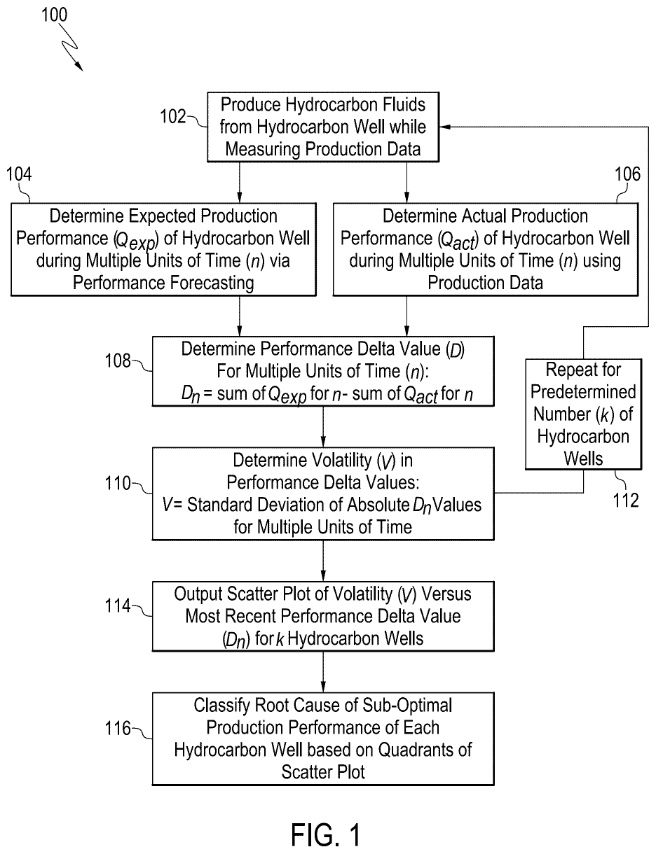

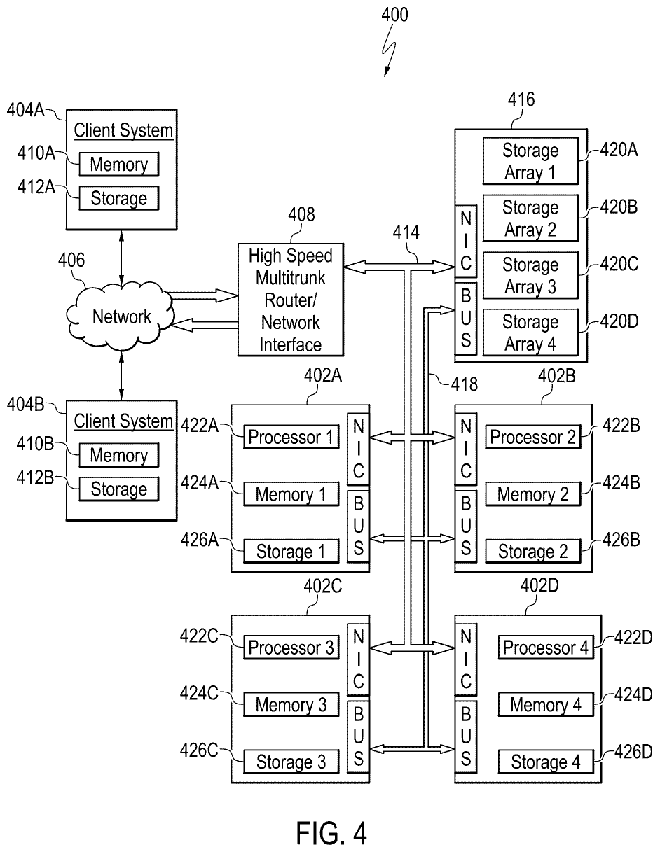

FIG. 1 is a process flow diagram of an exemplary method 100 for classifying the root cause of sub-optimal production performance for hydrocarbon wells associated with one or more unconventional reservoirs in accordance with the present disclosure. The method 100 may be executed, at least in part, by one or more computing systems including one or more processors, such as the exemplary cluster computing system described with respect to FIG. 4 (or any suitable variation(s) thereof). In some embodiments, such computing system(s) are positioned at the hydrocarbon field(s) at which the hydrocarbon wells are located and form part of the overall hydrocarbon well system. For example, the computing system(s) may form part of a mobile command center for directing the production operations performed with respect to the hydrocarbon wells.

The exemplary method 100 may begin at block 102, at which hydrocarbon fluids are produced from a hydrocarbon well while simultaneously measuring the corresponding production data. In various embodiments, the production data are measured in terms of the number of barrels of oil produced per day or the number of cubic feet of gas produced per day. However, any other suitable measurements of production performance may alternatively be utilized, depending on the details of the particular implementation.

At block 104, the expected production performance (Qₑₓₚ) of the hydrocarbon well during multiple units of time (n) is determined via performance forecasting. In particular, for embodiments in which the hydrocarbon well is already producing, decline curve analysis (DCA) procedures may be utilized to generate a production forecast for the hydrocarbon well, where the term “production forecast” refers to an estimate of the future performance of a hydrocarbon well that is generated based (at least in part) on historical performance data corresponding to the hydrocarbon well and/or historical performance data measured with respect to neighboring offset wells. In some embodiments, such production forecast is generated via the application of the Arp's equation and

DCA procedures to such historical performance data. Additionally or alternatively, in some embodiments, such production forecast is generated by inputting such historical performance data to a time-series machine learning model and/or a reservoir simulation model that is designed to forecast well performance. In some such embodiments, the time-series machine learning model is generated based on long short-term memory (LSTM) autoencoding techniques, although any other suitable machine learning techniques may alternatively be utilized. Moreover, for embodiments in which the hydrocarbon well is a new well that is not yet producing (or has not yet produced a substantial amount), DCA procedures may be utilized to generate a type curve that predicts the production performance of the hydrocarbon well. In such embodiments, the type curve may be generated by applying DCA procedures to historical performance data measured with respect to neighboring offset wells. (Notably, block 104 may be performed prior to block 102 in some instances, depending on whether the hydrocarbon well has already been put on production). Moreover, the actual production performance (Q_{act}) of the hydrocarbon well during the same units of time (n) is determined at block 106 using the production data from block 102.

In some embodiments, each unit of time correlates to a particular production phase. Moreover, each unit of time may be expressed as a number of days (although other increments of time may be utilized in some embodiments). For example, in some embodiments, the production performance is measured for the last 1 week, the last 2 weeks, the last 4 weeks, the last 8 weeks, and the last 12 weeks. In such embodiments, the value of n may be 7, 14, 28, 56, and 84, respectively. However, this is merely provided as an example of particular units of time that may be utilized since any other suitable units of time may be alternatively utilized, depending on the details of the particular implementation.

At block 108, the performance delta value (D) for the production performance of the hydrocarbon well is determined for each unit of time (n). More specifically, for each unit of time (n), the performance delta value (Dₙ) is determined according to Equation 1.

$${D}_{n} = sum of {Q}_{exp} for n - sum of {Q}_{act} for n \qquad Equation 1$$

Therefore, the resulting output from block 108 is a number of values for Dₙ (e.g., continuing with the above example, values for D₁. D₁₄, D₂₈, D₅₆, and D₈₄).

At block 110, the volatility (V) in the performance delta values is determined by determining the absolute of the values of Dₙ that were determined at block 108 and then calculating the standard deviation of such absolute values. This standard deviation may then be normalized using the maximum of the absolute values of Dₙ to enable comparison across multiple hydrocarbon wells, as described further with respect to block 114. Continuing with the above example, the volatility (V) may be determined as shown in Equation 2.

$$V = standard deviation ( \vert {D}_{7} \vert , \vert {D}_{14} \vert , \vert {D}_{28} \vert , \vert {D}_{56} \vert , \vert {D}_{84} \vert ) \qquad Equation 2$$

However, it should be noted that the determination of volatility according to the present disclosure is not limited to the utilization of standard deviation as the statistical metric. Instead, any suitable statistical metric may be utilized. As an example, in some embodiments, the volatility is determined by calculating the variance of the absolute of the values of Dₙ. Generally speaking, however, the present disclosure may utilize any statistical metric that effectively captures the variability in the performance delta values over the specified period of time, where such variability provides an indication of whether the production performance of the hydrocarbon well is erratic (i.e., varying abruptly over the specified period of time) or consistent (i.e., varying gradually or remaining relatively steady over the specified period of time).

At block 112, the method 100 loops back to block 102, as shown in FIG. 1, and blocks 102, 104, 106, 108, and 110 are repeated for each of a predetermined number (k) of hydrocarbon wells. The specific value of k may vary depending on the details of the particular implementation. As an example, in some embodiments, the value of k is within the range of 1,000 to 2,000. As another example, in some embodiments, the value of k is within the range of 250 to 1,000. Moreover, any other suitable value of k may be utilized. In general, the value of k is dependent on the number of hydrocarbon wells within the field of interest (or within multiple fields of interest). For embodiments in which hydrocarbon wells are selected from multiple fields of interest, such fields of interest may be neighboring or adjacent fields, or such fields may be more distantly-located fields that share common reservoir properties.

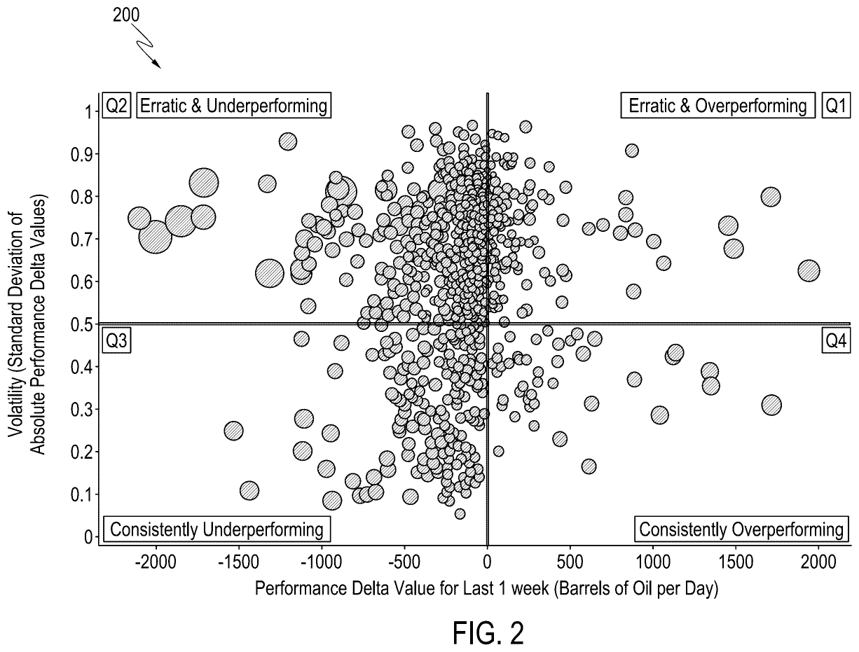

Once the volatility (V) in the performance delta values (Dₙ) has been determined for each hydrocarbon well, the method 100 proceeds to block 114, at which a scatter plot of the volatility (V) versus the most recent performance delta value (Dₙ) for each hydrocarbon well is generated and output (e.g., visually output via a display of a computing system, which may form part of the overall hydrocarbon well system, as described herein). Continuing with the above example and assuming that the most recent performance delta value is D₇, i.e., the performance delta value for the last 1 week, the exemplary scatter plot 200 shown in FIG. 2 may be generated. Specifically, FIG. 2 is an exemplary scatter plot 200 of the volatility of the performance delta values for each hydrocarbon well over the measured units of time (e.g., in this example, the last 1 week, the last 2 weeks, the last 4 weeks, the last 8 weeks, and the last 12 weeks) versus the performance delta value of the corresponding hydrocarbon well for the most recent unit of time (e.g., in this example, the last 1 week). Within the scatter plot 200 of FIG. 2, the performance delta values for the last 1 week (D₇) are represented by the x-axis, and the volatility (i.e., in this example, the standard deviation of the absolute performance delta values over the measured units of time) is represented by the y-axis. Each hydrocarbon well therefore appears as a dot within the scatter plot 200. The location of each dot along the x-axis is indicative of whether each hydrocarbon well is currently underperforming (in which case D₇ is lower) or overperforming (in which case D is higher), while the location of each dot along the y-axis is indicative of whether the production performance of each hydrocarbon well is consistent (in which case the volatility is lower, meaning that the production performance varies gradually) or erratic (in which case the volatility is higher, meaning that the production performance varies abruptly). In other words, the x-axis indicates the extent to which the hydrocarbon well is meeting the production performance expectations, while the y-axis indicates whether the production performance is relatively steady or highly variable over time.

Proceeding now to block 116, the root cause of the sub-optimal production performance of each hydrocarbon well is classified based on the quadrants of the scatter plot generated at block 114. Specifically, looking at the exemplary scatter plot 200 of FIG. 2, it is desirable for each hydrocarbon well to approximate the centerline on the x-axis (i.e., D7=0) because that would indicate that the hydrocarbon well is performing as expected (i.e., Q_{act} approximates Qₑₓₚ). In addition, it is desirable for each hydrocarbon well to approximate the bottom of the y-axis (i.e., V=0) because that would indicate that the hydrocarbon well is consistent (i.e., has a low volatility). Therefore, as shown in FIG. 2, most of the hydrocarbon wells are performing sub-optimally in some manner.

Accordingly, the present disclosure provides a quadrant-based approach for classifying the root cause of the sub-optimal performance as being one or more subsurface uncertainties, one or more operational limitations, or some combination of subsurface uncertainties and operational limitations. Looking at the exemplary scatter plot 200 of FIG. 2, the first quadrant (Q1) in the top right of the scatter plot 200 represents hydrocarbon wells that are erratic and overperforming, which corresponds to a root cause classification of subsurface uncertainty. The second quadrant (Q2) in the top left of the scatter plot 200 represents hydrocarbon wells that are erratic and underperforming, which corresponds to a root cause classification of operational limitation. The third quadrant (Q3) in the bottom left of the scatter plot 200 represents hydrocarbon wells that are consistently underperforming, which corresponds to a root cause classification of subsurface uncertainty and operational limitation. The fourth quadrant (Q4) in the bottom right of the scatter plot 200 represents hydrocarbon wells that are consistently overperforming, which corresponds to a root cause classification of subsurface uncertainty. Therefore, the root cause of the sub-optimal production performance for each hydrocarbon well can be easily determined based on the hydrocarbon well's representative location within the scatter plot 200. In other words, if the dot representing the hydrocarbon well is within Q1, a classification of subsurface uncertainty is output; if the dot representing the hydrocarbon well is within Q2, a classification of operational limitation is output; if the dot representing the hydrocarbon well is within Q3, a classification of subsurface uncertainty and operational limitation is output; and if the dot representing the hydrocarbon well is within Q4, a classification of subsurface uncertainty is output.

Once the hydrocarbon wells have been classified at block 116, one or more remedial actions may be taken with respect to the hydrocarbon wells in order to improve the production performance of such wells. In particular, turning first to hydrocarbon wells that fall within Q1 of the scatter plot 200, such hydrocarbon wells are performing better than expected, but such overperformance is inconsistent. This indicates that the production operation could potentially benefit from reforecasting of the subsurface conditions (e.g., by modifying one or more subsurface model(s) corresponding to the subsurface formation) to account for one or more subsurface uncertainties. In various embodiments, this includes updating the expected production performance for the hydrocarbon well based on newly-acquired production data corresponding to such well. For hydrocarbon wells that fall within Q2 of the scatter plot 200, such hydrocarbon wells are performing worse than expected, and such underperformance is inconsistent. This indicates that the production operation could benefit from the application of production optimization techniques to mitigate one or more operational limitations. Such production optimization techniques may include, but are not limited to, increasing the gas-lift injection rate, altering the frequency of the ESP, changing the lift type (e.g., between gas-lift, ESP, rod pump, gas-assisted plunger lift (GAPL), or the like), conducting an acid cleanout job, performing a re-perforating operation, and/or performing a re-fracturing operation. For hydrocarbon wells that fall within Q3 of the scatter plot 200, such hydrocarbon wells are performing worse than expected, and such underperformance is consistent. This indicates that the production operation could potentially benefit from reforecasting of the subsurface conditions to account for one or more subsurface uncertainties and/or the application of production optimization techniques to mitigate one or more long-term operational limitations. For hydrocarbon wells that fall within Q4 of the scatter plot 200, such hydrocarbon wells are performing better than expected, and such overperformance is consistent. This indicates that the production operation could potentially benefit from reforecasting of the subsurface conditions to account for one or more subsurface uncertainties (although such action may be considered to be lower priority in this case since the hydrocarbon well is consistently overperforming). Accordingly, in this manner, the sub-optimal production performance root cause classification provided by the present disclosure enables actions to be taken in the field such that the production performance of the hydrocarbon wells is optimized (or at least substantially optimized), thus resulting in the more efficient production of hydrocarbon fluids from such wells.

Those skilled in the art will appreciate that the exemplary method 100 of FIG. 1 is susceptible to modification without altering the technical effect provided by the present disclosure. In practice, the exact manner in which the method 100 is implemented will depend, at least in part, on the details of the specific implementation. For example, in some embodiments, some of the blocks shown in FIG. 1 may be altered or omitted from the method 100 and/or new blocks may be added to the method 100, without departing from the scope of the present disclosure.

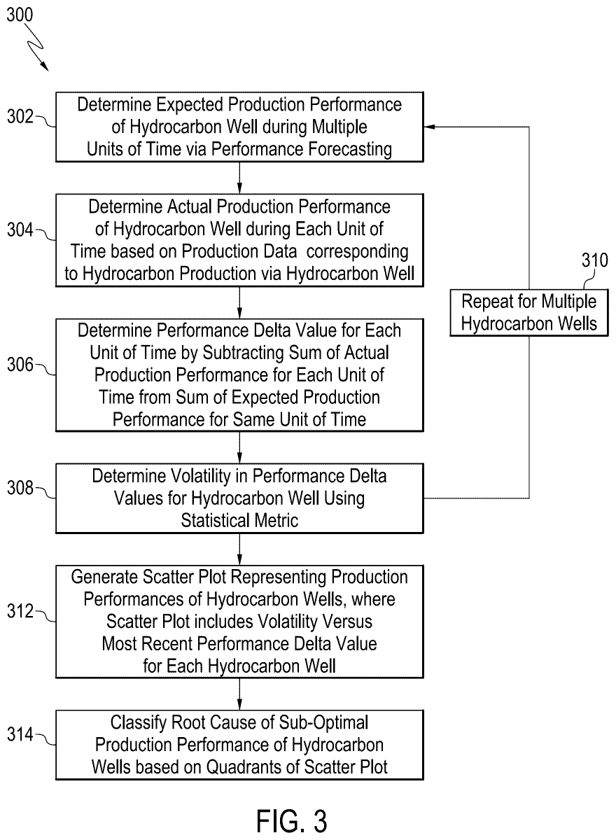

FIG. 3 is a simplified process flow diagram of an exemplary method 300 for classifying the root cause of sub-optimal production performance for hydrocarbon wells associated with one or more unconventional reservoirs in accordance with the present disclosure. In various embodiments, the method 300 (or at least a portion of the method 300) correlates to the method 100 described with respect to FIG. 1 (and/or to any suitable variation of such method). The method 300 may be executed, at least in part, by one or more computing systems including one or more processors, such as the exemplary cluster computing system described with respect to FIG. 4 (or any suitable variation(s) thereof). In some embodiments, such computing system(s) are positioned at the hydrocarbon field(s) at which the hydrocarbon wells are located and form part of the overall hydrocarbon well system. For example, the computing system(s) may form part of a mobile command center for directing the production operations performed with respect to the hydrocarbon wells.

The method 300 begins at block 302, at which the expected production performance of a hydrocarbon well during multiple units of time is determined via performance forecasting. In various embodiments, this corresponds to block 104 of the method 100 (or any suitable variation thereof). In various embodiments, this includes first determining whether the hydrocarbon well has already been put on production (meaning that the hydrocarbon well has been producing for a sufficient period of time to allow for the measurement of corresponding production data). If the hydrocarbon well has already been put on production, a production forecast that projects the expected production performance of the hydrocarbon well during the multiple units of time is generated. In such embodiments, the production forecast may be generated by applying the Arp's equation and DCA procedures to historical performance data corresponding to the hydrocarbon well and/or one or more offset wells. Alternatively, in such embodiments, the production forecast may be generated by inputting historical performance data corresponding to the hydrocarbon well and/or one or more offset wells to a time-series machine learning model and/or a reservoir simulation model that is designed to forecast well performance. Moreover, if the hydrocarbon well has not already been put on production, a type curve is generated to predict the expected production performance of the hydrocarbon well during the multiple units of time.

At block 304, the actual production performance of the hydrocarbon well during each unit of time is determined based on production data corresponding to hydrocarbon production via the hydrocarbon well. In various embodiments, this corresponds to block 106 of the method 100 (or any suitable variation thereof). Moreover, in some embodiments, method 100 also includes, for at least a portion of the hydrocarbon wells, prior to determining the actual production performance of the hydrocarbon well during each of the multiple units of time: (1) producing hydrocarbon fluids via the hydrocarbon well; and (2) measuring the production data during the production of the hydrocarbon fluids via the hydrocarbon well.

In some embodiments, the expected production performance for each hydrocarbon well during a particular unit of time is the expected number of barrels of oil or the expected number of cubic feet of gas to be produced by the hydrocarbon well per day during the unit of time, and the actual production performance is the actual number of barrels of oil or the actual number of cubic feet of gas, respectively, produced by the hydrocarbon well per day during the unit of time. In other embodiments, the expected production performance for each hydrocarbon well during a particular unit of time is the expected pressure normalized rate for the hydrocarbon well, which is determined by dividing the expected number of barrels of oil or the expected number of cubic feet of gas to be produced by the hydrocarbon well per day by the pressure drawdown for the hydrocarbon well, and the actual production performance is the actual pressure normalized rate, which is determined by dividing the actual number of barrels of oil or the actual number of cubic feet of gas, respectively, produced by the hydrocarbon well per day during the unit of time by the pressure drawdown for the hydrocarbon well.

At block 306, the performance delta value for each unit of time is determined by subtracting the sum of the actual production performance for each unit of time from the sum of the expected production performance for the same unit of time. In various embodiments, this corresponds to block 108 of the method 100 (or any suitable variation thereof).

At block 308, the volatility in the performance delta values for the hydrocarbon well is determined using a statistical metric. In various embodiments, this corresponds to block 110 of the method 100 (or any suitable variation thereof). In some embodiments, the statistical metric is standard deviation, and the volatility in the performance delta values is determined by determining the absolute value of each of the performance delta values for the hydrocarbon well and then calculating the standard deviation of the absolute values. In such embodiments, the standard deviation of the absolute values may optionally be normalized based on the maximum of the absolute values to allow easier comparison across multiple hydrocarbon wells. In other embodiments, the statistical metric is variance. Moreover, in other embodiments, any other suitable statistical metric may be utilized.

At block 310, blocks 302, 304, 306, and 308 are repeated for each remaining hydrocarbon well within a group of multiple hydrocarbon wells within the same field (and/or adjacent fields), resulting in the output of the performance delta values for each unit of time and the volatility in the performance delta values for each hydrocarbon well. In various embodiments, this corresponds to block 112 of the method 100.

The method 300 then proceeds to block 312, at which a scatter plot representing the production performances of the multiple hydrocarbon wells is generated. In various embodiments, this corresponds to block 114 of the method 100 (or any suitable variation thereof), as well as the exemplary scatter plot 200 of FIG. 2, for example. As described herein, the scatter plot includes the volatility in the performance delta values for each hydrocarbon well versus the most recent performance delta value for the corresponding hydrocarbon well, where the most recent performance delta value is the performance delta value for the unit of time corresponding to the most recently-occurring time period. As an example, for embodiments in which the units of time are expressed in terms of the number of days of hydrocarbon production, a first unit of time may be equal to 7 days, a second unit of time may be equal to 14 days, a third unit of time may be equal to 28 days, a fourth unit of time may be equal to 56 days, and a fifth unit of time may be equal to 84 days. In such embodiments, the unit of time corresponding to the most recently-occurring time period is the first unit of time (i.e., 7 days).

At block 314, the root cause of the sub-optimal production performance of at least a portion of the hydrocarbon wells is classified based on the quadrants of the scatter plot. In various embodiments, this corresponds to block 116 of the method 100 (or any suitable variation thereof). In various embodiments, this may include: (1) classifying any hydrocarbon wells that fall within the first quadrant within the top right of the scatter plot with the root cause classification of subsurface uncertainty; (2) classifying any hydrocarbon wells that fall within the second quadrant within the top left of the scatter plot with the root cause classification of operation limitation; (3) classifying any hydrocarbon wells that fall within the third quadrant within the bottom left of the scatter plot with the root cause classification of subsurface uncertainty and operational limitation; and (4) classifying any hydrocarbon wells that fall within the fourth quadrant within the bottom right of the scatter plot with the root cause classification of subsurface uncertainty.

Those skilled in the art will appreciate that the exemplary method 300 of FIG. 3 is susceptible to modification without altering the technical effect provided by the present disclosure. In practice, the exact manner in which the method 300 is implemented will depend, at least in part, on the details of the specific implementation. For example, in some embodiments, some of the blocks shown in FIG. 3 may be altered or omitted from the method 300 and/or new blocks may be added to the method 300, without departing from the scope of the present disclosure. As an example, in some embodiments, the method 300 further includes modifying one or more parameters corresponding to hydrocarbon production from at least one of the hydrocarbon wells based on the classification of the root cause of the sub-optimal production performance for the hydrocarbon well(s). As an example, for one or more hydrocarbon wells including the root cause classification of subsurface uncertainty and/or the root cause classification of subsurface uncertainty and operational limitation, subsurface conditions may be reforecasted to account for one or more subsurface uncertainties. As another example, for one or more hydrocarbon wells including the root cause classification of operational limitation and/or the root cause classification of subsurface uncertainty and operational limitation, one or more production optimization techniques may be performed in the field to mitigate one or more operational limitations. As described herein, this may include, for example, increasing the gas-lift injection rate for one or more of the hydrocarbon wells, altering the frequency of the ESP for one or more of the hydrocarbon wells, changing the lift type (e.g., between gas-lift, ESP, rod pump, GAPL, or the like) for one or more of the hydrocarbon wells, conducting an acid cleanout job for one or more of the hydrocarbon wells, performing a re-perforating operation for one or more of the hydrocarbon wells, and/or performing a re-fracturing operation for one or more of the hydrocarbon wells.

FIG. 4 is a block diagram of an exemplary cluster computing system 400 that may be utilized to implement at least a portion of the present disclosure. The exemplary cluster computing system 400 shown in FIG. 4 has four computing units 402A, 402B, 402C, and 402D, each of which may perform calculations for a portion of the present disclosure. However, one of ordinary skill in the art will recognize that the cluster computing system 400 is not limited to this configuration, as any number of computing configurations may be selected. For example, a smaller analysis may be run on a single computing unit, such as a workstation, while a large calculation may be run on a cluster computing system 400 having tens, hundreds, or even more computing units.

The cluster computing system 400 may be accessed from any number of client systems 404A and 404B over a network 406, for example, through a high-speed network interface 408. The computing units 402A to 402D may also function as client systems, providing both local computing support and access to the wider cluster computing system 400.

The network 406 may include a local area network (LAN), a wide area network (WAN), the Internet, or any combinations thereof. Each client system 404A and 404B may include one or more non-transitory, computer-readable storage media for storing the operating code and program instructions that are used to implement at least a portion of the present disclosure, as described further with respect to the non-transitory, computer-readable storage media of FIG. 4. For example, each client system 404A and 404B may include a memory device 410A and 410B, which may include random access memory (RAM), read only memory (ROM), and the like. Each client system 404A and 404B may also include a storage device 412A and 412B, which may include any number of hard drives, optical drives, flash drives, or the like.

The high-speed network interface 408 may be coupled to one or more buses in the cluster computing system 400, such as a communications bus 414. The communication bus 414 may be used to communicate instructions and data from the high-speed network interface 408 to a cluster storage system 416 and to each of the computing units 402A to 402D in the cluster computing system 400. The communications bus 414 may also be used for communications among the computing units 402A to 402D and the cluster storage system 416. In addition to the communications bus 414, a high-speed bus 418 can be present to increase the communications rate between the computing units 402A to 402D and/or the cluster storage system 416.

In some embodiments, the one or more non-transitory, computer-readable storage media of the cluster storage system 416 include storage arrays 420A, 420B, 420C and 420D for the storage of models, data. visual representations, results (such as graphs, charts, and the like used to convey results obtained using the methods of the present disclosure), code, and other information concerning the implementation of at least a portion of the present disclosure. The storage arrays 420A to 420D may include any combinations of hard drives, optical drives, flash drives, or the like.

Each computing unit 402A to 402D includes at least one processor 422A, 422B, 422C and 422D and associated local non-transitory, computer-readable storage media, such as a memory device 424A, 424B, 424C and 424D and a storage device 426A, 426B, 426C and 426D, for example. Each processor 422A to 422D may be a multiple core unit, such as a multiple core central processing unit (CPU) or a graphics processing unit (GPU). Each memory device 424A to 424D may include ROM and/or RAM used to store program instructions for directing the corresponding processor 422A to 422D to implement at least a portion of the present disclosure. Each storage device 426A to 426D may include one or more hard drives, optical drives, flash drives, or the like. In addition, each storage device 426A to 426D may be used to provide storage for models, intermediate results, data, images, or code used to implement at least a portion of the present disclosure.

The present disclosure is not limited to the architecture or unit configuration illustrated in FIG. 4. For example, any suitable processor-based device may be utilized for implementing at least a portion of the embodiments described herein, including (without limitation) personal computers, laptop computers, computer workstations, mobile devices, and multi-processor servers or workstations with (or without) shared memory. Moreover, the embodiments described herein may be implemented, at least in part, on application specific integrated circuits (ASICs) or very-large-scale integrated (VLSI) circuits. In fact, those skilled in the art may utilize any number of suitable structures capable of executing logical operations according to the embodiments described herein.

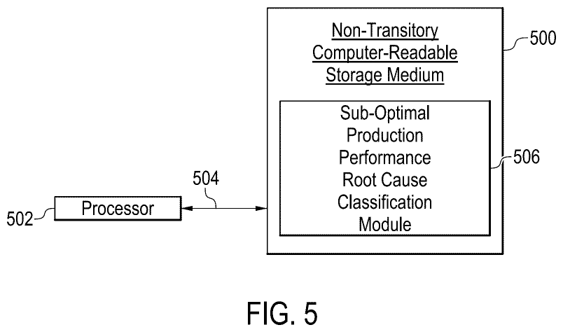

FIG. 5 is a block diagram of an exemplary non-transitory, computer-readable storage medium 500 that may be used for the storage of data and modules of program instructions for implementing at least a portion of the present disclosure. The non-transitory, computer-readable storage medium 500 may include a memory device, a hard disk, and/or any number of other devices, as described herein. A processor 502 may access the non-transitory, computer-readable storage medium 500 over a bus or network 504. While the non-transitory, computer-readable storage medium 500 may include any number of modules for implementing the present disclosure, in some embodiments, the non-transitory, computer-readable storage medium 500 includes a sub-optimal production performance root cause classification module 506 for performing the processes described herein (and/or any suitable variations thereof), as described with respect to the methods 100 and/or 300 of FIGS. 1 and/or 3, respectively.

This disclosure can include one or more of the following non-limiting aspects and/or embodiments:
A1. A method for classifying a root cause of a sub-optimal production performance for hydrocarbon wells associated with at least one unconventional reservoir. At least a portion of the method is implemented via a computing system including a processor. The method includes: for each of a number of hydrocarbon wells: determining an expected production performance of the hydrocarbon well during each of multiple units of time via performance forecasting; determining an actual production performance of the hydrocarbon well during each of the multiple units of time based on production data corresponding to hydrocarbon production via the hydrocarbon well; determining a performance delta value for each of the multiple units of time by subtracting the sum of the actual production performance for each unit of time from the sum of the expected production performance for the same unit of time; and determining a volatility in the performance delta values for the hydrocarbon well using a statistical metric. The method also includes: generating a scatter plot representing production performances of the number of hydrocarbon wells, where the scatter plot includes the volatility in the performance delta values for each hydrocarbon well versus a most recent performance delta value for the corresponding hydrocarbon well, and where the most recent performance delta value includes the performance delta value for the unit of time corresponding to a most recently-occurring time period; and classifying a root cause of a sub-optimal production performance of at least a portion of the hydrocarbon wells based on quadrants of the scatter plot.
A2. The method of A1, including modifying at least one parameter corresponding to hydrocarbon production from at least one of the hydrocarbon wells based on the classification of the root cause of the sub-optimal production performance for the at least one of the hydrocarbon wells.
A3. The method of A1 or A2, where classifying the root cause of the sub-optimal production performance of the at least the portion of the hydrocarbon wells based on the quadrants of the scatter plot includes: classifying any hydrocarbon wells that fall within a first quadrant within a top right of the scatter plot with a root cause classification of subsurface uncertainty; classifying any hydrocarbon wells that fall within a second quadrant within a top left of the scatter plot with a root cause classification of operation limitation; classifying any hydrocarbon wells that fall within a third quadrant within a bottom left of the scatter plot with a root cause classification of subsurface uncertainty and operational limitation; and classifying any hydrocarbon wells that fall within a fourth quadrant within a bottom right of the scatter plot with the root cause classification of subsurface uncertainty.
A4. The method of A3, further including, for at least one hydrocarbon well including the root cause classification of subsurface uncertainty or the root cause classification of subsurface uncertainty and operational limitation, performing reforecasting of subsurface conditions to account for at least one subsurface uncertainty.
A5. The method of A3 or A4, further including, for at least one hydrocarbon well including the root cause classification of operational limitation or the root cause classification of subsurface uncertainty and operational limitation, performing at least one production optimization technique to mitigate at least one operational limitation.
A6. The method of any of A1 to A5, further including, for at least a portion of the hydrocarbon wells, prior to determining the actual production performance of the hydrocarbon well during each of the multiple units of time: producing hydrocarbon fluids via the hydrocarbon well; and measuring the production data during the production of the hydrocarbon fluids via the hydrocarbon well.
A7. The method of any of A1 to A6, where determining the expected production performance of each hydrocarbon well during each of the multiple units of time via the performance forecasting includes: determining whether the hydrocarbon well has already been put on production; if the hydrocarbon well has already been put on production, generating a production forecast that projects the expected production performance of the hydrocarbon well during the multiple units of time; or if the hydrocarbon well has not already been put on production, generating a type curve that predicts the expected production performance of the hydrocarbon well during the multiple units of time.
A8. The method of A7, including generating the production forecast by applying an Arp's equation and DCA procedures to historical performance data corresponding to at least one of the hydrocarbon well or at least one offset well.
A9. The method of A7, including generating the production forecast by inputting historical performance data corresponding to at least one of the hydrocarbon well or at least one offset well to at least one of a time-series machine learning model or a reservoir simulation model.
A10. The method of any of A1 to A9, where the expected production performance for each hydrocarbon well during a particular unit of time includes an expected number of barrels of oil or an expected number of cubic feet of gas to be produced by the hydrocarbon well per day during the unit of time, and where the actual production performance includes an actual number of barrels of oil or an actual number of cubic feet of gas, respectively, produced by the hydrocarbon well per day during the unit of time.
A11. The method of any of A1 to A9, where the expected production performance for each hydrocarbon well during a particular unit of time includes an expected pressure normalized rate that is determined by dividing an expected number of barrels of oil or an expected number of cubic feet of gas to be produced by the hydrocarbon well per day during the unit of time by a pressure drawdown for the hydrocarbon well, and where the actual production performance includes an actual pressure normalized rate that is determined by dividing an actual number of barrels of oil or an actual number of cubic feet of gas, respectively, produced by the hydrocarbon well per day during the unit of time by the pressure drawdown for the hydrocarbon well.
A12. The method of any of A1 to A11, where each of the multiple units of time is expressed in terms of a number of days of hydrocarbon production.
A13. The method of A12, where the multiple units of time include a first unit of time that is equal to 7 days, a second unit of time that is equal to 14 days, a third unit of time that is equal to 28 days, a fourth unit of time that is equal to 56 days, and a fifth unit of time that is equal to 84 days, and where the unit of time corresponding to the most recently-occurring time period is the first unit of time.
A14. The method of any of A1 to A13, where the statistical metric is standard deviation, and where determining the volatility in the performance delta values for each hydrocarbon well using the statistical metric includes: determining an absolute value of each of the performance delta values for the hydrocarbon well; and calculating the standard deviation of the absolute values.
A15. The method of A14, where determining the volatility in the performance delta values for each hydrocarbon well includes normalizing the standard deviation of the absolute values based on a maximum of the absolute values.
A16. The method of any of A1 to A13, where the statistical metric is variance.
B1. A hydrocarbon well system, including: multiple hydrocarbon wells, where hydrocarbon fluids are produced from each hydrocarbon well concurrently with a measurement of corresponding production data; and a computing system that is communicably coupled to the multiple hydrocarbon wells, where the computing system includes: a processor; and a non-transitory, computer-readable storage medium including program instructions that are executable by the processor to cause the processor to: determine an expected production performance of a hydrocarbon well of the multiple hydrocarbon wells during each of multiple units of time via performance forecasting; determine an actual production performance of the hydrocarbon well during each of the multiple units of time based on the production data corresponding to the hydrocarbon well; determine a performance delta value for each of the multiple units of time by subtracting the sum of the actual production performance for each unit of time from the sum of the expected production performance for the same unit of time; determine a volatility in the performance delta values for the hydrocarbon well using a statistical metric; repeat the determination of the expected production performance, the determination of the actual production performance, the determination of the performance delta value for each of the multiple units of time, and the determination of the volatility in the performance delta values for each remaining hydrocarbon well of the multiple hydrocarbon wells; generate a scatter plot representing production performances of the multiple hydrocarbon wells, where the scatter plot includes the volatility in the performance delta values for each hydrocarbon well of the multiple hydrocarbon wells versus a most recent performance delta value for the same hydrocarbon well of the multiple hydrocarbon wells, and where the most recent performance delta value includes the performance delta value for the unit of time corresponding to a most recently-occurring time period; and classify a root cause of a sub-optimal production performance of at least a portion of the multiple hydrocarbon wells based on quadrants of the scatter plot.
B2. The hydrocarbon well system of B1, where the non-transitory, computer-readable storage medium includes program instructions that are executable by the processor to cause the processor to classify the root cause of the sub-optimal production performance of the at least the portion of the multiple hydrocarbon wells based on the quadrants of the scatter plot by: classifying any of the multiple hydrocarbon wells that fall within a first quadrant within a top right of the scatter plot with a root cause classification of subsurface uncertainty; classifying any of the multiple hydrocarbon wells that fall within a second quadrant within a top left of the scatter plot with a root cause classification of operation limitation; classifying any of the multiple hydrocarbon wells that fall within a third quadrant within a bottom left of the scatter plot with a root cause classification of subsurface uncertainty and operational limitation; and classifying any of the multiple hydrocarbon wells that fall within a fourth quadrant within a bottom right of the scatter plot with the root cause classification of subsurface uncertainty.
B3. The hydrocarbon well system of B2, where the non-transitory, computer-readable storage medium includes program instructions that are executable by the processor to cause the processor to, for at least one hydrocarbon well including the root cause classification of subsurface uncertainty or the root cause classification of subsurface uncertainty and operational limitation, perform reforecasting of subsurface conditions to account for at least one subsurface uncertainty.
B4. The hydrocarbon well system of B2 or B3, where the non-transitory, computer-readable storage medium includes program instructions that are executable by the processor to cause the processor to, for at least one hydrocarbon well including the root cause classification of operational limitation or the root cause classification of subsurface uncertainty and operational limitation, perform at least one production optimization technique to mitigate at least one operational limitation.
B5. The hydrocarbon well system of any of B1 to B4, where the non-transitory, computer-readable storage medium includes program instructions that are executable by the processor to cause the processor to determine the expected production performance of the hydrocarbon well of the multiple hydrocarbon wells during each of the multiple units of time via the performance forecasting by: determining whether the hydrocarbon well has already been put on production; if the hydrocarbon well has already been put on production, generating a production forecast that projects the expected production performance of the hydrocarbon well during the multiple units of time; or if the hydrocarbon well has not already been put on production, generating a type curve that predicts the expected production performance of the hydrocarbon well during the multiple units of time.
B6. The hydrocarbon well system of B5, where the non-transitory, computer-readable storage medium includes program instructions that are executable by the processor to cause the processor to generate the production forecast by applying an Arp's equation and decline curve analysis (DCA) procedures to historical performance data corresponding to at least one of the hydrocarbon well or at least one offset well.
B7. The hydrocarbon well system of B5, where the non-transitory, computer-readable storage medium includes program instructions that are executable by the processor to cause the processor to generate the production forecast by inputting historical performance data corresponding to at least one of the hydrocarbon well or at least one offset well to at least one of a time-series machine learning model or a reservoir simulation model.
B8. The hydrocarbon well system of any of B1 to B7, where the expected production performance for each hydrocarbon well during a particular unit of time includes an expected number of barrels of oil or an expected number of cubic feet of gas to be produced by the hydrocarbon well per day during the unit of time, and where the actual production performance includes an actual number of barrels of oil or an actual number of cubic feet of gas, respectively, produced by the hydrocarbon well per day during the unit of time.
B9. The hydrocarbon well system of any of B1 to B7, where the expected production performance for each hydrocarbon well during a particular unit of time includes an expected pressure normalized rate that is determined by dividing an expected number of barrels of oil or an expected number of cubic feet of gas to be produced by the hydrocarbon well per day during the unit of time by a pressure drawdown for the hydrocarbon well, and where the actual production performance includes an actual pressure normalized rate that is determined by dividing an actual number of barrels of oil or an actual number of cubic feet of gas, respectively, produced by the hydrocarbon well per day during the unit of time by the pressure drawdown for the hydrocarbon well.
B10. The hydrocarbon well system of any of B1 to B9, where each of the multiple units of time is expressed in terms of a number of days of hydrocarbon production.
B11. The hydrocarbon well system of any of B1 to B10, where the statistical metric includes a standard deviation, and where the non-transitory, computer-readable storage medium includes program instructions that are executable by the processor to cause the processor to determine the volatility in the performance delta values for the hydrocarbon well using the statistical metric by: determining an absolute value of each of the performance delta values for the hydrocarbon well; and calculating the standard deviation of the absolute values.
C1. A non-transitory, computer-readable storage medium, including program instructions that are executable by a processor to cause the processor to: measure production data corresponding to hydrocarbon production via a hydrocarbon well of multiple hydrocarbon wells; determine an expected production performance of the hydrocarbon well during each of multiple units of time via performance forecasting; determine an actual production performance of the hydrocarbon well during each of the multiple units of time based on the measured production data; determine a performance delta value for each of the multiple units of time by subtracting the sum of the actual production performance for each unit of time from the sum of the expected production performance for the same unit of time; determine a volatility in the performance delta values for the hydrocarbon well using a statistical metric; repeat the determination of the expected production performance, the determination of the actual production performance, the determination of the performance delta value for each of the multiple units of time, and the determination of the volatility in the performance delta values for each remaining hydrocarbon well of the multiple hydrocarbon wells; generate a scatter plot representing production performances of the multiple hydrocarbon wells, where the scatter plot includes the volatility in the performance delta values for each hydrocarbon well of the multiple hydrocarbon wells versus a most recent performance delta value for the same hydrocarbon well of the multiple hydrocarbon wells, and where the most recent performance delta value includes the performance delta value for the unit of time corresponding to a most recently-occurring time period; and classify a root cause of a sub-optimal production performance of at least a portion of the multiple hydrocarbon wells based on quadrants of the scatter plot by: (a) classifying any of the multiple hydrocarbon wells that fall within a first quadrant within a top right of the scatter plot with a root cause classification of subsurface uncertainty; (b) classifying any of the multiple hydrocarbon wells that fall within a second quadrant within a top left of the scatter plot with a root cause classification of operation limitation; (c) classifying any of the multiple hydrocarbon wells that fall within a third quadrant within a bottom left of the scatter plot with a root cause classification of subsurface uncertainty and operational limitation; and (d) classifying any of the multiple hydrocarbon wells that fall within a fourth quadrant within a bottom right of the scatter plot with the root cause classification of subsurface uncertainty.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present disclosure may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present disclosure includes all alternatives, modifications, and equivalents falling within the true spirit and scope of the appended claims.

What is claimed is:

1. A method for classifying a root cause of a sub-optimal production performance for hydrocarbon wells associated with at least one unconventional reservoir, wherein at least a portion of the method is implemented via a computing system comprising a processor, and wherein the method comprises:
for each of a plurality of hydrocarbon wells:
determining an expected production performance of the hydrocarbon well during each of multiple units of time via performance forecasting;
determining an actual production performance of the hydrocarbon well during each of the multiple units of time based on production data corresponding to hydrocarbon production via the hydrocarbon well;
determining a performance delta value for each of the multiple units of time by subtracting the sum of the actual production performance for each unit of time from the sum of the expected production performance for the same unit of time; and
determining a volatility in the performance delta values for the hydrocarbon well using a statistical metric;
generating a scatter plot representing production performances of the plurality of hydrocarbon wells, wherein the scatter plot comprises the volatility in the performance delta values for each hydrocarbon well versus a most recent performance delta value for the corresponding hydrocarbon well, and wherein the most recent performance delta value comprises the performance delta value for the unit of time corresponding to a most recently-occurring time period; and
classifying a root cause of a sub-optimal production performance of at least a portion of the hydrocarbon wells based on quadrants of the scatter plot.

2. The method of claim 1, comprising modifying at least one parameter corresponding to hydrocarbon production from at least one of the hydrocarbon wells based on the classification of the root cause of the sub-optimal production performance for the at least one of the hydrocarbon wells.

3. The method of claim 1, wherein classifying the root cause of the sub-optimal production performance of the at least the portion of the hydrocarbon wells based on the quadrants of the scatter plot comprises:
classifying any hydrocarbon wells that fall within a first quadrant within a top right of the scatter plot with a root cause classification of subsurface uncertainty;
classifying any hydrocarbon wells that fall within a second quadrant within a top left of the scatter plot with a root cause classification of operation limitation;
classifying any hydrocarbon wells that fall within a third quadrant within a bottom left of the scatter plot with a root cause classification of subsurface uncertainty and operational limitation; and
classifying any hydrocarbon wells that fall within a fourth quadrant within a bottom right of the scatter plot with the root cause classification of subsurface uncertainty.

4. The method of claim 3, further comprising, for at least one hydrocarbon well comprising the root cause classification of subsurface uncertainty or the root cause classification of subsurface uncertainty and operational limitation, performing reforecasting of subsurface conditions to account for at least one subsurface uncertainty.

5. The method of claim 3, further comprising, for at least one hydrocarbon well comprising the root cause classification of operational limitation or the root cause classification of subsurface uncertainty and operational limitation, performing at least one production optimization technique to mitigate at least one operational limitation.

6. The method of claim 1, further comprising, for at least a portion of the hydrocarbon wells, prior to determining the actual production performance of the hydrocarbon well during each of the multiple units of time:
producing hydrocarbon fluids via the hydrocarbon well; and
measuring the production data during the production of the hydrocarbon fluids via the hydrocarbon well.

7. The method of claim 1, wherein determining the expected production performance of each hydrocarbon well during each of the multiple units of time via the performance forecasting comprises:
determining whether the hydrocarbon well has already been put on production;
if the hydrocarbon well has already been put on production, generating a production forecast that projects the expected production performance of the hydrocarbon well during the multiple units of time; or
if the hydrocarbon well has not already been put on production, generating a type curve that predicts the expected production performance of the hydrocarbon well during the multiple units of time.

8. The method of claim 7, comprising generating the production forecast by applying an Arp's equation and decline curve analysis (DCA) procedures to historical performance data corresponding to at least one of the hydrocarbon well or at least one offset well.

9. The method of claim 7, comprising generating the production forecast by inputting historical performance data corresponding to at least one of the hydrocarbon well or at least one offset well to at least one of a time-series machine learning model or a reservoir simulation model.

10. The method of claim 1, wherein the expected production performance for each hydrocarbon well during a particular unit of time comprises an expected number of barrels of oil or an expected number of cubic feet of gas to be produced by the hydrocarbon well per day during the unit of time, and wherein the actual production performance comprises an actual number of barrels of oil or an actual number of cubic feet of gas, respectively, produced by the hydrocarbon well per day during the unit of time.

11. The method of claim 1, wherein the expected production performance for each hydrocarbon well during a particular unit of time comprises an expected pressure normalized rate that is determined by dividing an expected number of barrels of oil or an expected number of cubic feet of gas to be produced by the hydrocarbon well per day during the unit of time by a pressure drawdown for the hydrocarbon well, and wherein the actual production performance comprises an actual pressure normalized rate that is determined by dividing an actual number of barrels of oil or an actual number of cubic feet of gas, respectively, produced by the hydrocarbon well per day during the unit of time by the pressure drawdown for the hydrocarbon well.

12. The method of claim 1, wherein each of the multiple units of time is expressed in terms of a number of days of hydrocarbon production.

13. The method of claim 12, wherein the multiple units of time comprise a first unit of time that is equal to 7 days, a second unit of time that is equal to 14 days, a third unit of time that is equal to 28 days, a fourth unit of time that is equal to 56 days, and a fifth unit of time that is equal to 84 days, and wherein the unit of time corresponding to the most recently-occurring time period is the first unit of time.

14. The method of claim 1, wherein the statistical metric comprises a standard deviation, and wherein determining the volatility in the performance delta values for each hydrocarbon well using the statistical metric comprises:
determining an absolute value of each of the performance delta values for the hydrocarbon well; and
calculating the standard deviation of the absolute values.

15. The method of claim 14, wherein determining the volatility in the performance delta values for each hydrocarbon well comprises normalizing the standard deviation of the absolute values based on a maximum of the absolute values.

16. The method of claim 1, wherein the statistical metric comprises a variance.

17. A hydrocarbon well system, comprising:
multiple hydrocarbon wells, wherein hydrocarbon fluids are produced from each hydrocarbon well concurrently with a measurement of corresponding production data; and
a computing system that is communicably coupled to the multiple hydrocarbon wells,
wherein the computing system comprises:
a processor; and
a non-transitory, computer-readable storage medium comprising program instructions that are executable by the processor to cause the processor to:
determine an expected production performance of a hydrocarbon well of the multiple hydrocarbon wells during each of multiple units of time via performance forecasting;
determine an actual production performance of the hydrocarbon well during each of the multiple units of time based on the production data corresponding to the hydrocarbon well;
determine a performance delta value for each of the multiple units of time by subtracting the sum of the actual production performance for each unit of time from the sum of the expected production performance for the same unit of time;
determine a volatility in the performance delta values for the hydrocarbon well using a statistical metric;
repeat the determination of the expected production performance, the determination of the actual production performance, the determination of the performance delta value for each of the multiple units of time, and the determination of the volatility in the performance delta values for each remaining hydrocarbon well of the multiple hydrocarbon wells;
generate a scatter plot representing production performances of the multiple hydrocarbon wells, wherein the scatter plot comprises the volatility in the performance delta values for each hydrocarbon well of the multiple hydrocarbon wells versus a most recent performance delta value for the same hydrocarbon well of the multiple hydrocarbon wells, and wherein the most recent performance delta value comprises the performance delta value for the unit of time corresponding to a most recently-occurring time period; and
classify a root cause of a sub-optimal production performance of at least a portion of the multiple hydrocarbon wells based on quadrants of the scatter plot.

18. The hydrocarbon well system of claim 17, wherein the non-transitory, computer-readable storage medium comprises program instructions that are executable by the processor to cause the processor to classify the root cause of the sub-optimal production performance of the at least the portion of the multiple hydrocarbon wells based on the quadrants of the scatter plot by:
classifying any of the multiple hydrocarbon wells that fall within a first quadrant within a top right of the scatter plot with a root cause classification of subsurface uncertainty;
classifying any of the multiple hydrocarbon wells that fall within a second quadrant within a top left of the scatter plot with a root cause classification of operation limitation;
classifying any of the multiple hydrocarbon wells that fall within a third quadrant within a bottom left of the scatter plot with a root cause classification of subsurface uncertainty and operational limitation; and
classifying any of the multiple hydrocarbon wells that fall within a fourth quadrant within a bottom right of the scatter plot with the root cause classification of subsurface uncertainty.

19. The hydrocarbon well system of claim 18, wherein the non-transitory, computer-readable storage medium comprises program instructions that are executable by the processor to cause the processor to, for at least one hydrocarbon well comprising the root cause classification of subsurface uncertainty or the root cause classification of subsurface uncertainty and operational limitation, perform reforecasting of subsurface conditions to account for at least one subsurface uncertainty.

20. The hydrocarbon well system of claim 18, wherein the non-transitory, computer-readable storage medium comprises program instructions that are executable by the processor to cause the processor to, for at least one hydrocarbon well comprising the root cause classification of operational limitation or the root cause classification of subsurface uncertainty and operational limitation, perform at least one production optimization technique to mitigate at least one operational limitation.

21. The hydrocarbon well system of claim 17, wherein the non-transitory, computer-readable storage medium comprises program instructions that are executable by the processor to cause the processor to determine the expected production performance of the hydrocarbon well of the multiple hydrocarbon wells during each of the multiple units of time via the performance forecasting by:
determining whether the hydrocarbon well has already been put on production;
if the hydrocarbon well has already been put on production, generating a production forecast that projects the expected production performance of the hydrocarbon well during the multiple units of time; or
if the hydrocarbon well has not already been put on production, generating a type curve that predicts the expected production performance of the hydrocarbon well during the multiple units of time.

22. The hydrocarbon well system of claim 21, wherein the non-transitory, computer-readable storage medium comprises program instructions that are executable by the processor to cause the processor to generate the production forecast by applying an Arp's equation and decline curve analysis (DCA) procedures to historical performance data corresponding to at least one of the hydrocarbon well or at least one offset well.

23. The hydrocarbon well system of claim 21, wherein the non-transitory, computer-readable storage medium comprises program instructions that are executable by the processor to cause the processor to generate the production forecast by inputting historical performance data corresponding to at least one of the hydrocarbon well or at least one offset well to at least one of a time-series machine learning model or a reservoir simulation model.

24. The hydrocarbon well system of claim 17, wherein the expected production performance for each hydrocarbon well during a particular unit of time comprises an expected number of barrels of oil or an expected number of cubic feet of gas to be produced by the hydrocarbon well per day during the unit of time, and wherein the actual production performance comprises an actual number of barrels of oil or an actual number of cubic feet of gas, respectively, produced by the hydrocarbon well per day during the unit of time.

25. A non-transitory, computer-readable storage medium, comprising program instructions that are executable by a processor to cause the processor to:
measure production data corresponding to hydrocarbon production via a hydrocarbon well of multiple hydrocarbon wells;
determine an expected production performance of the hydrocarbon well during each of multiple units of time via performance forecasting;
determine an actual production performance of the hydrocarbon well during each of the multiple units of time based on the measured production data;
determine a performance delta value for each of the multiple units of time by subtracting the sum of the actual production performance for each unit of time from the sum of the expected production performance for the same unit of time;
determine a volatility in the performance delta values for the hydrocarbon well using a statistical metric;
repeat the determination of the expected production performance, the determination of the actual production performance, the determination of the performance delta value for each of the multiple units of time, and the determination of the volatility in the performance delta values for each remaining hydrocarbon well of the multiple hydrocarbon wells;
generate a scatter plot representing production performances of the multiple hydrocarbon wells, wherein the scatter plot comprises the volatility in the performance delta values for each hydrocarbon well of the multiple hydrocarbon wells versus a most recent performance delta value for the same hydrocarbon well of the multiple hydrocarbon wells, and wherein the most recent performance delta value comprises the performance delta value for the unit of time corresponding to a most recently-occurring time period; and
classify a root cause of a sub-optimal production performance of at least a portion of the multiple hydrocarbon wells based on quadrants of the scatter plot by:
classifying any of the multiple hydrocarbon wells that fall within a first quadrant within a top right of the scatter plot with a root cause classification of subsurface uncertainty;
classifying any of the multiple hydrocarbon wells that fall within a second quadrant within a top left of the scatter plot with a root cause classification of operation limitation;
classifying any of the multiple hydrocarbon wells that fall within a third quadrant within a bottom left of the scatter plot with a root cause classification of subsurface uncertainty and operational limitation; and
classifying any of the multiple hydrocarbon wells that fall within a fourth quadrant within a bottom right of the scatter plot with the root cause classification of subsurface uncertainty.
